(19) United States
(12) Patent Application Publication
(10) Pub. No.: US 2012/0202135 A1
(43) Pub. Date: Aug. 9, 2012

(54) IMPROVED CATALYST COATED MEMBRANES HAVING COMPOSITE, THIN MEMBRANES AND THIN CATHODES FOR USE IN DIRECT METHANOL FUEL CELLS

(75) Inventors: Biswajit Choudhury, Wilmington, DE (US); Harvey P. Tannenbaum, Wynnewood, PA (US)

(73) Assignee: E.I. DU PONT DE NEMOURS AND COMPANY, Wilmington, DE (US)

(21) Appl. No.: 13/393,551

(22) PCT Filed: Sep. 3, 2010
(86) PCT No.: PCT/US2010/047812

§ 371 Date: Mar. 1, 2012

Related U.S. Application Data
(60) Provisional application No. 61/239,623, filed on Sep. 3, 2009.

(51) Int. Cl. H01M 8/10

(52) U.S. Cl. 429/482

(57) ABSTRACT

The invention relates to DMFC catalyst coated membranes having improved water crossover and methanol crossover performance, excellent power output and durability, which utilize a thin composite reinforced polymer membrane layer and a thin cathode layer to achieve these performance benefits, and methods of making these catalyst coated membranes. The catalyst coated membrane for use in a direct methanol fuel cell have an anode layer, a thin cathode layer, a thin reinforced ionomer membrane, and do not rely on any additional barrier layers or complex water and/or methanol management layers or peripherals or to improve performance.

### FIELD OF THE INVENTION

The invention relates to catalyst coated membranes having improved water crossover and methanol crossover performance, excellent power output and durability, which utilize a thin composite reinforced polymer membrane layer and a thin cathode layer to achieve these performance benefits, and methods of making these catalyst coated membranes.

### BACKGROUND OF THE INVENTION

A variety of electrochemical cells falls within a category of cells often referred to as solid polymer electrolyte (“SPE”) cells. An SPE cell typically employs a membrane of a cation exchange polymer that serves as a physical separator between the anode and cathode while also serving as an electrolyte. SPE cells can be operated as electrolytic cells for the production of electrochemical products or they may be operated as fuel cells.

Fuel cells are electrochemical cells that convert reactants, namely fuel and oxidant fluid streams, to generate electric power and reaction products. A broad range of reactants can be used in fuel cells and such reactants may be delivered in gaseous or liquid streams. For example, the fuel stream may be substantially pure hydrogen gas, a gaseous hydrogen containing reformate stream, or an aqueous alcohol, for example methanol in a direct methanol fuel cell (DMFC). The oxidant may, for example, be substantially pure oxygen or a dilute oxygen stream such as air.

In SPE fuel cells, the solid polymer electrolyte membrane is typically perfluorinated sulfonic acid polymer membrane in acid form. Such fuel cells are often referred to as proton exchange membrane (“PEM”) fuel cells. The membrane is disposed between and in contact with the anode and the cathode. Electrocatalysts in the anode and the cathode typically induce the desired electrochemical reactions and may be, for example, a metal black, an alloy or a metal catalyst supported on a substrate, e.g., platinum on carbon. SPE fuel cells typically also comprise a porous, electrically conductive sheet material that is in electrical contact with each of the electrodes, and permit diffusion of the reactants to the electrodes. In fuel cells that employ gaseous reactants, this porous, conductive sheet material is sometimes referred to as a gas diffusion backing or layer and is suitably provided by a carbon fiber paper or carbon cloth. An assembly including the membrane, anode and cathode, and gas diffusion backings for each electrode, is sometimes referred to as a membrane electrode assembly (“MEA”). As used herein “MEA” means such a five layer structure including a membrane, anode and cathode, and gas diffusion backings for each electrode. Plates, made of a conductive material and providing flow fields for the reactants, are placed between a number of adjacent MEAs. A number of MEAs and bipolar plates are assembled in this manner to provide a fuel cell stack.

The solid polymer electrolyte membrane is not only physically central to the MEA, it is also required to perform a variety of essential functions in order that the fuel cell stack operate properly and generate electrical energy with both reliability and durability.

Composite polymer electrolyte membranes are known, for example in U.S. Pat. No. 5,547,551 a thin composite membrane is described which includes a base material and an ion exchange resin. U.S. Pat. No. 5,547,551 states that Nafion® ion exchange membranes that are not reinforced are inherently weak, and furthermore ion exchange membranes must be reinforced at small thicknesses with additional materials causing the final product to have increased thickness. U.S. Pat. Nos. 3,692,569, 4,453,991 and 4,469,744 to Grot; U.S. Pat. Nos. 4,902,308, 4,954,388, and 5,082,472 to Mallouk, et al. U.S. Pat. Nos. 5,094,895 and 5,183,545 to Branca, et al.; U.S. Pat. No. 4,341,615 to Bachot, et al.; U.S. Pat. No. 4,604,170 to Miyake et al.; U.S. Pat. No. 4,865,925 to Ludwig, et al.; and Japanese Patent Application Nos. 62-240627, 62-280230 and 62-280231 are all discussed therein as they relate to a composite membrane structure.

However, design of fuel cells for the many applications discussed above is not a one size fits all endeavor, and DMFC fuel cell design is no exception. Special care must be taken to consider a variety of complex factors which may be unique to, for example, the specific DMFC application. Accordingly, a membrane selection for one application may work well, but may perform poorly in a different application. Commonly assigned U.S. Pat. No. 5,795,668 to Banerjee discloses a reinforced membrane especially for use in a direct methanol fuel cell, and states that from the point of view of thermodynamic efficiency, such fuel cells constitute the most advantageous method for the direct conversion of fuel to electrical energy; however, it is desirable to reduce the so-called “crossover” of fuel through the polymeric membrane.

In the fuel cell technology, the term “crossover” refers to the undesirable transport of fuel through the polymer electrolyte layer from the fuel electrode or anode side to the air/oxygen electrode or cathode side of the fuel cell. FIG. 5 is a schematic drawing which depicts both the methanol crossover and the water crossover in a methanol fuel cell. After having been transported across the membrane, the fuel will either evaporate into the circulating air/oxygen stream or react with the oxygen at the air/oxygen electrode.

The fuel crossover diminishes cell performance for two primary reasons. First, the transported fuel cannot react electrochemically and, therefore, contributes directly to a loss of fuel efficiency (effectively a fuel leak). Secondly, the transported fuel interacts with the cathode (often an air/oxygen electrode) and lowers its operating potential and hence the overall cell potential. The reduction of cell potential lowers specific cell power output and also reduces the overall efficiency.

Banerjee further states that efforts to date (in this instance 1994) to improve the fuel crossover have focused on (i) experimenting with flow rate, concentration and temperature of the fuel mixture; (ii) improving cathode catalysts insensitivity to the presence of fuel in the oxidant stream; and (iii) experimenting with alternate fuels or fuel mixtures which may result in lower crossover rates. In his invention Banerjee focuses on the polymeric ion exchange membrane and measures methanol permeation for hydrolyzed samples of reinforced membrane.

Over a decade has elapsed since U.S. Pat. No. 5,795,668 to Banerjee issued, and numerous solutions have been proposed in MEA's to address methanol crossover as well as water crossover in DMFC applications. WO 2007/070399 proposes a ceramic porous frit filled with ion exchange material, U.S. published patent application 2005/0170224 proposes an alternative to existing complex systems which actively circulate water back into the anode. 2005/0170224 discloses a water management element to push liquid water back from the cathode to the anode through the cell membrane. This element is a hydrophobic microporous layer utilized as a water management membrane disposed in the cathode chamber of the fuel cell between the cathode diffusion layer and the catalyzed membrane electrolyte. Water that is produced in the cathode half reaction is blocked by the barrier to liquid water penetration presented by a microporous hydrophobic layer which consequently applies back hydrostatic pressure which pushes water from the cathode back into and through the membrane electrolyte.

Other proposed solutions have similar themes, all involving additional elements to manage or block the water crossover. Or, alternately, one commercially known system merely uses a thick 5 mil cast, unreinforced membrane to lessen water and methanol transfer. Because most DMFC applications involve low power output devices, consequently more efforts have been put into the low power output DMFC application which encompasses personal electronic devices and the like.

A simple yet elegant solution to the problem of managing both water crossover and methanol crossover in a high power output DMFC application has been surprisingly discovered.

Although in light of all the proposed solutions discussed above it would be considered counter-intuitive to use a thinner polymer electrolyte membrane, or not to use additional barriers or water removal elements, quite unexpectedly the combination of a thin composite polymer electrolyte membrane with a thin cathode layer provides improved power output, improved stoichiometry along with greater durability and longer life while managing both water and methanol crossover.

### SUMMARY OF THE INVENTION

The invention provides a thinner polymer electrolyte membrane, and without using additional barriers or water removal elements, quite unexpectedly the combination of a thin composite polymer electrolyte membrane with a thin cathode layer provides improved power output, improved stoichiometry along with greater durability and longer life while managing both water and methanol crossover. The invention provides a catalyst coated membrane for use in a direct methanol fuel cell comprising: an anode layer, a cathode layer having a thickness less than 7 microns, a reinforced ionomer membrane having a thickness of 30 microns or less, wherein said reinforced ionomer membrane is disposed between and in direct contact with said anode and said cathode. In other embodiments the catalyst coated membrane has a reinforcement of ePTFE and the reinforced ionomer membrane comprises perfluorosulfonic acid ionomer which has substantially all of the functional groups being represented by the formula —SO₃X wherein X is H.

In embodiments of the invention, the catalyst coated membrane of the invention may have a reinforced cathode layer has a thickness of between 4 and 6 microns and also a reinforced ionomer membrane with a thickness of 25 microns or less.

The catalyst coated membrane of the invention provides at least 10% higher cell voltage at high current density and improved decay rates when compared to a catalyst coated membrane having a 5 mil thick non-reinforced ionomer membrane and a 1 mil thick cathode layer. Moreover, the catalyst coated membrane of the invention has a performance drop of less than 15% when air stoichiometry is dropped from 3 to 2, when compared to a catalyst coated membrane having a 5 mil thick non-reinforced ionomer membrane and a 1 mil thick cathode layer, and also has functional voltage output when air stoichiometry is 1.8.

### BRIEF DESCRIPTION OF THE DRAWINGS

FIG. 1 is a plot of durability of the invention compared to existing DMFC devices.

FIG. 2 is another plot of durability of the invention compared to existing DMFC devices.

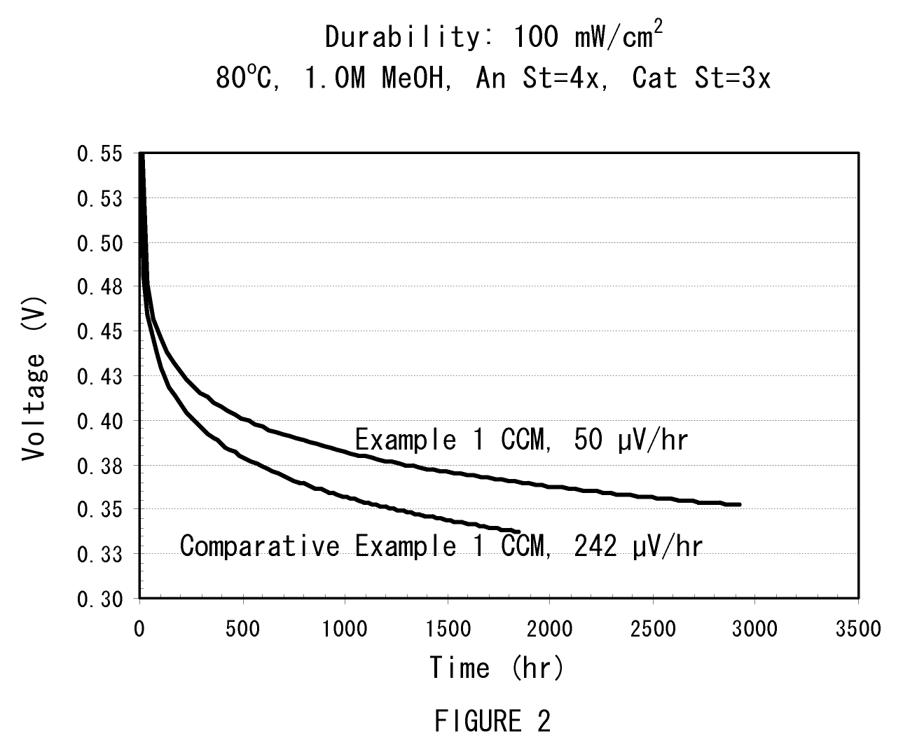

FIG. 3 is a plot of air stoichiometry of the invention compared to existing DMFC devices.

FIG. 4 is a plot of voltage and power output of the invention compared to existing DMFC devices.

FIG. 5 is a depiction of the elements, chemistry and operation of a DMFC device.

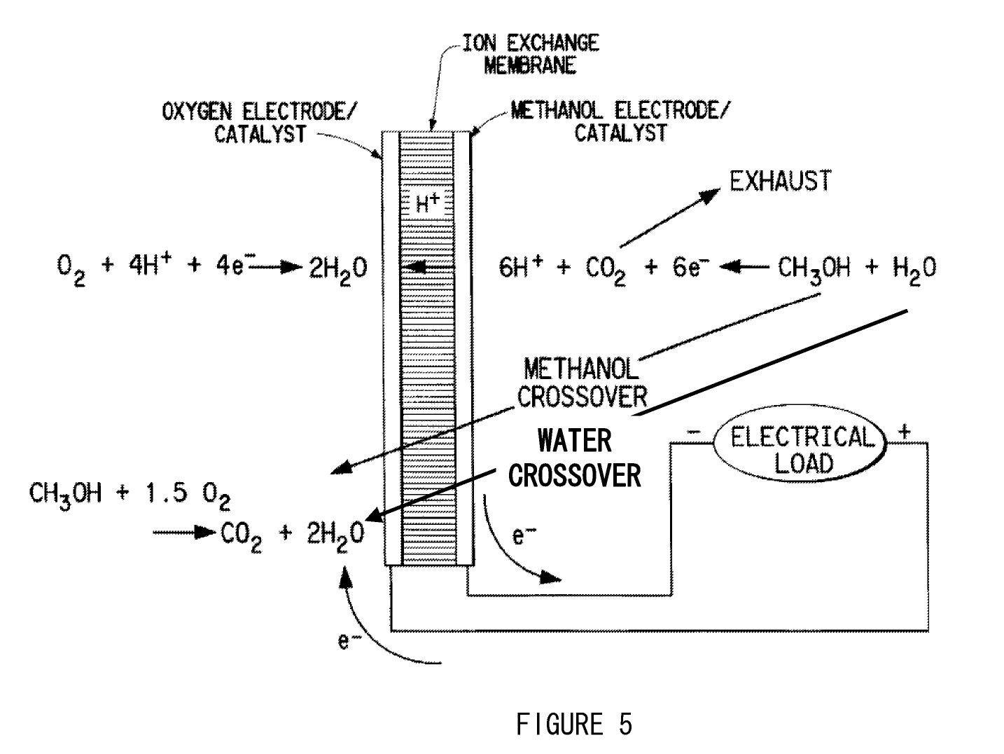

### DETAILED DESCRIPTION OF THE INVENTION

### Ion Exchange Polymers

The compositions and method in accordance with the present invention employ highly fluorinated sulfonate polymer, i.e., having sulfonate functional groups in the resulting composite membrane. “Highly fluorinated” means that at least 90% of the total number of univalent atoms in the polymer are fluorine atoms. Most preferably, the polymer is perfluorinated. The term “sulfonate functional groups” is intended to refer to either to sulfonic acid groups or salts of sulfonic acid groups, preferably alkali metal or ammonium salts. Most preferably, the functional groups are represented by the formula —SO₃X wherein X is H, Li, Na, K or N(R¹)(R²)(R³)(R⁴) and R¹, R², R³, and R⁴ are the same or different and are H, CH₃ or C₂H₅. In embodiments of the invention where the polymer is to be used for proton exchange, the sulfonic acid form of the polymer is preferred, i.e., where X is H in the formula above. In further embodiments of the invention, substantially all of the functional groups (i.e., approaching and/or achieving 100%) are represented by the formula —SO₃X wherein X is H.

Preferably, the polymer comprises a polymer backbone with recurring side chains attached to the backbone with the side chains carrying the cation exchange groups. Possible polymers include homopolymers or copolymers of two or more monomers. Copolymers are typically formed from one monomer which is a nonfunctional monomer and which provides carbon atoms for the polymer backbone. A second monomer provides both carbon atoms for the polymer backbone and also contributes the side chain carrying the cation exchange group or its precursor, e.g., a sulfonyl halide group such a sulfonyl fluoride (—SO₂F), which can be subsequently hydrolyzed to a sulfonate functional group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidine fluoride, trifluoroethylene, chlorotrifluoroethylene, perfluoro (alkyl vinyl ether), and mixtures thereof. Possible second monomers include a variety of fluorinated vinyl ethers with sulfonate functional groups or precursor groups which can provide the desired side chain in the polymer. The first monomer may also have a side chain which does not interfere with the ion exchange function of the sulfonate functional group. Additional monomers can also be incorporated into these polymers if desired.

A class of preferred polymers for use in the present invention include a highly fluorinated, most preferably perfluorinated, carbon backbone and the side chain is represented by the formula —(O—CF₂CFR_{f})ₐ—O—CF₂CFR′_{f}SO₃X, wherein R_{f} and R′_{f} are independently selected from F, Cl or a perfluorinated alkyl group having 1 to 10 carbon atoms, a=0, 1 or 2, and X is H, Li, Na, K or N(R¹)(R²)(R³)(R⁴) and R¹, R², R³, and R⁴ are the same or different and are H, CH₃ or C₂H₅. The preferred polymers include, for example, polymers disclosed in U.S. Pat. No. 3,282,875 and in U.S. Pat. Nos. 4,358,545 and 4,940,525. One preferred polymer comprises a perfluorocarbon backbone and the side chain is represented by the formula —O—CF₂CF(CF₃)—O—CF₂CF₂SO₃X, wherein X is as defined above. Polymers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl halide groups and ion exchanging if needed to convert to the desired form. One preferred polymer of the type disclosed in U.S. Pat. Nos. 4,358,545 and 4,940,525 has the side chain —O—CF₂CF₂SO₃X, wherein X is as defined above. This polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange if needed.

In embodiments of the present invention, highly fluorinated carboxylate polymer, i.e., having carboxylate functional groups in the resulting composite membrane, may be employed as will be discussed in more detail hereinafter. The term “carboxylate functional groups” is intended to refer to either to carboxylic acid groups or salts of carboxylic acid groups, preferably alkali metal or ammonium salts. Most preferably, the functional groups are represented by the formula —CO₂X wherein X is H, Li, Na, K or N(R¹)(R²)(R³)(R⁴) and R¹, R², R³, and R⁴ are the same or different and are H, CH₃ or C₂H₅. The polymer may comprise a polymer backbone with recurring side chains attached to the backbone with the side chains carrying the carboxylate functional groups. Polymers of this type are disclosed in U.S. Pat. No. 4,552,631 and most preferably have the side chain —O—CF₂CF(CF₃)—O—CF₂CF₂CO₂X. This polymer can be made by copolymerization of tetrafluoroethylene (TFE) and the perfluorinated vinyl ether CF₂═CF—O—CF₂CF(CF₃)—O—CF₂CF₂CO₂CH₃, methyl ester of perfluoro(4,7-dioxa-5-methyl-8-nonenecarboxylic acid) (PDMNM), followed by conversion to carboxylate groups by hydrolysis of the methyl carboxylate groups and ion exchanging if needed to convert to the desired form. While other esters can be used for film or bifilm fabrication, the methyl ester is the preferred since it is sufficiently stable during normal extrusion conditions.

In this application, “ion exchange ratio” or “IXR” is defined as number of carbon atoms in the polymer backbone in relation to the cation exchange groups. A wide range of IXR values for the polymer are possible. Typically, however, the IXR range used for layers of the membrane is usually about 7 to about 33. For perfluorinated polymers of the type described above, the cation exchange capacity of a polymer is often expressed in terms of equivalent weight (EW). For the purposes of this application, equivalent weight (EW) is defined to be the weight of the polymer in acid form required to neutralize one equivalent of NaOH. In the case of a sulfonate polymer where the polymer comprises a perfluorocarbon backbone and the side chain is —O—CF₂—CF(CF₃)—O—CF₂—CF₂—SO₃H (or a salt thereof), the equivalent weight range which corresponds to an IXR of about 7 to about 33 is about 700 EW to about 2000 EW. IXR for this polymer can be related to equivalent weight using the following formula: 50 IXR+344=EW. While generally the same IXR range is used for sulfonate polymers disclosed in U.S. Pat. Nos. 4,358,545 and 4,940,525, the equivalent weight is somewhat lower because of the lower molecular weight of the monomer unit containing a cation exchange group. For the IXR range of about 7 to about 33, the corresponding equivalent weight range is about 500 EW to about 1800 EW. IXR for this polymer can be related to equivalent weight using the following formula: 50 IXR+178=EW. For carboxylate polymers having the side chain

—O—CF₂CF(CF₃)—O—CF₂CF₂CO₂X, a useful IXR range is about 12 to about 21 which corresponds to about 900 EW to about 1350 EW. IXR for this polymer can be related to equivalent weight using the following formula: 50 IXR+308=EW.

IXR is used in this application to describe either hydrolyzed polymer which contains functional groups or unhydrolyzed polymer which contains precursor groups which will subsequently be converted to the functional groups during the manufacture of the membranes.

The highly fluorinated sulfonate polymer used in the process of the invention preferably has ion exchange ratio of about 8 to about 23, more preferably about 9 to about 14 and most preferably about 10 to about 13.

### Microporous Supports

The microporous supports useful in a process of the invention are made of highly fluorinated nonionic polymers. As for the ion exchange polymers, “highly fluorinated” means that at least 90% of the total number of halogen and hydrogen atoms in the polymer are fluorine atoms.

For increased resistance to thermal and chemical degradation, and good methanol and water crossover properties the microporous support is preferably is made of a perfluorinated polymer. For example, the polymer for the porous support can be polytetrafluoroethylene (PTFE) or a copolymer of tetrafluoroethylene with

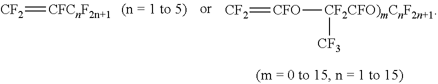

Microporous PTFE sheeting is well known and is particularly suitable for use as the microporous support. One support is expanded polytetrafluoroethylene polymer (EPTFE) having a microstructure of polymeric fibrils, or a microstructure of nodes interconnected by the fibrils. Films having a microstructure of polymeric fibrils with no nodes present are also useful. The preparation of such suitable supports is described in U.S. Pat. No. 3,593,566 and U.S. Pat. No. 3,962,153. These patents disclose the extruding of dispersion-polymerized PTFE in the presence of a lubricant into a tape and subsequently stretching under conditions which make the resulting material more porous and stronger. Heat treatment of the expanded PTFE under restraint to above the PTFE melting point (approximately 342° C.) increases the amorphous content of the PTFE. Films made in this manner can have a variety of pore sizes and void volumes. U.S. Pat. Nos. 3,953,566, 3,962,153 and 4,187,390 disclose porous PTFE films having at least 35% voids. Pore size can vary but is typically at least about 0.2 μm. The thickness of the porous support can be varied depending on the type of composite to be made. Preferably, the thickness is about 20 μm to about 400 μm, most preferably, 30 μm to about 60 μm.

Suitable microporous PTFE supports are available commercially from W. L. Gore & Associates, Elkton Md., under the trademark GORE-TEX® and from Tetratec, Feasterville, Pa., under the trademark TETRATEX®.

Microporous supports made using other manufacturing processes with other highly fluorinated nonionic polymers may also be used in the process of the invention. Such polymers may be selected from the broad spectrum of homopolymers and copolymers made using fluorinated monomers. Possible fluorinated monomers include vinyl fluoride; vinylidene fluoride; trifluoroethylene; chlorotrifluoroethylene (CTFE); 1,2-difluoroethylene; tetrafluoroethylene (TFE); hexafluoropropylene (HFP); perfluoro(alkyl vinyl)ethers such as perfluoro(methyl vinyl)ether (PMVE), perfluoro(ethyl vinyl)ether (PEVE), and perfluoro(propyl vinyl) ether (PPVE); perfluoro(1,3-dioxole); perfluoro(2,2-dimethyl-1,3-dioxole) (PDD); F(CF₂)ₙCH₂OCF═CF₂ wherein n is 1, 2, 3, 4 or 5; R¹CH₂OCF═CF₂ wherein R¹ is hydrogen or F(CF₂)ₘ— and m is 1, 2 or 3; and R³OCF═CH₂ wherein R³ is F(CF₂)_{z}— and z is 1, 2, 3 or 4; perfluorobutyl ethylene (PFBE); 3,3,3-trifluoropropene and 2-trifluoromethyl-3,3,3-trifluoro-1-propene.

If desired, the microporous support may also include an attached fabric, preferably a woven fabric. Most preferably, such fabrics are made of a yarn of a highly fluorinated polymer, preferably PTFE. If such fabrics are to be used, they are preferably securely attached to the PTFE support as supplied for use in the process. Suitable woven fabrics include scrims of woven fibers of expanded PTFE, webs of extruded or oriented fluoropolymer or fluoropolymer netting, and woven materials of fluoropolymer fiber. Nonwoven materials include spun-bonded fluoropolymer may also be used if desired.

The reinforced composite membrane in accordance with the invention may be assembled from the ion exchange polymers and microporous supports described above in any manner of art recognized methods, so long as the resultant reinforced composite membrane results in the ion exchange polymer present in the reinforced composite membrane having substantially all of the functional groups (i.e., approaching and/or achieving 100%) being represented by the formula —SO₃X wherein X is H.

In embodiments in accordance with the methods of the invention, it may be important not to carry out hydrolysis of the SO₂F groups to SO₃H in situ, for example hydrolysis of an electrode layer which has already been assembled to the reinforced composite membrane. In embodiments of the invention, certain desirable reinforced composite membranes in accordance with the invention are prepared by taking a microporous support such as EPTFE and imbibing it with a Nafion® dispersion which already has all of the functional groups (i.e., approaching and/or achieving 100%) being represented by the formula —SO₃X wherein X is H, then drying the imbibed support, and then annealing the dried imbibed support.

However, in instances where an electrode ink having ion exchange polymer containing all of the functional groups (i.e., approaching and/or achieving 100%) being represented by the formula —SO₃X wherein X is F is used to prepare an electrode, and then that electrode is attached to the reinforced composite membrane, and then the attached electrode is hydrolyzed in situ to convert the SO₂F groups to SO₃H, unacceptable results may be obtained. Without wishing to be bound by any suggested theory or hypothesis, it is suggested that a skin or layer is formed on the reinforced composite membranes in accordance with the invention are prepared by taking a microporous support such as EPTFE and imbibing it with a Nafion® dispersion which already has all of the functional groups (i.e., approaching and/or achieving 100%) being represented by the formula —SO₃X wherein X is H, then drying the imbibed support. This skin may be disturbed, or even damaged or destroyed, by the hydrolysis process performed on the electrode, and swelling may also occur in the reinforced composite membranes in accordance with the invention. The result of this, as stated above, is that the resultant structure does not have acceptable performance.

### Electrocatalyst Compositions

The electrocatalyst compositions in accordance with the invention an electrocatalyst and an ion exchange polymer; and the anode and cathode coating compositions may be the same or different. The ion exchange polymer may perform several functions in the resulting electrode including serving as a binder for the electrocatalyst and improving ionic conductivity to catalyst sites. Optionally, other components are included in the composition, e.g., PTFE in particle form.

Electrocatalysts in the composition are selected based on the particular intended application for the catalyst layer. Electrocatalysts suitable for use in the present invention include one or more platinum group metal such as platinum, ruthenium, rhodium, and iridium and electroconductive oxides thereof, and electroconductive reduced oxides thereof. The catalyst may be supported or unsupported. For direct methanol fuel cells, a (Pt—Ru)O_{X} electrocatalyst has been found to be useful. These compositions when employed accordance with the procedures described herein, provided particles in the electrode which are less than 1 μm in size.

Since the ion exchange polymer employed in the electrocatalyst coating composition serves not only as binder for the electrocatalyst particles but also may assist in securing the electrode to the membrane, it is preferable for the ion exchange polymers in the composition to be compatible with the ion exchange polymer in the membrane. Ion exchange polymers in the electrocatalyst coating composition may be the same type as the ion exchange polymer in the membrane or may be different.

Ion exchange polymers for use in accordance with the present invention are described above.

If the polymer in the electrocatalyst coating composition is not in sulfonic acid form when used, a post treatment acid exchange step will be required to convert the polymer to acid form prior to use. As described above, it is important not to impact the properties of the composite reinforced polymer membrane by such post treatment steps.

The electrocatalyst coating or catalyst layer may be formed from a slurry or ink. The liquid medium for the ink is one selected to be compatible with the process of application. The inks may be applied to the membrane by any known technique to form a catalyst-coated membrane. Alternately, the inks may be applied to the gas diffusion backing. Some known application techniques include screen, offset, gravure, flexographic or pad printing, or slot-die, doctor-blade, dip, or spray coating. It is advantageous for the medium to have a sufficiently low boiling point that rapid drying of electrode layers is possible under the process conditions employed. When using flexographic or pad printing techniques, it is important that the composition not dry so fast that it dries on the flexographic plate or the cliché plate or the pad before transfer to the membrane film.

A wide variety of polar organic liquids or mixtures thereof can serve as suitable liquid media for the ink. Water in minor quantity may be present in the medium if it does not interfere with the printing process. Some preferred polar organic liquids have the capability to swell the membrane in large quantity although the amount of liquids the electrocatalyst coating composition applied in accordance with the invention is sufficiently limited that the adverse effects from swelling during the process are minor or undetectable. It is believed that solvents with the capability to swell the polymer membrane can provide better contact and more secure application of the electrode to the membrane. A variety of alcohols are well suited for use as the liquid medium.

Preferred liquid media include suitable C4 to C8 alkyl alcohols including, n-, iso-, sec- and tert-butyl alcohols; the isomeric 5-carbon alcohols, 1,2- and 3-pentanol, 2-methyl-1-butanol, 3-methyl, 1-butanol, etc., the isomeric 6-carbon alcohols, e.g. 1-, 2-, and 3-hexanol, 2-methyl-1-pentanol, 3-methyl-1-pentanol, 2-methyl-1-pentanol, 3-methyl, 1-pentanol, 4-methyl-1-pentanol, etc., the isomeric C7 alcohols and the isomeric C8 alcohols. Cyclic alcohols are also suitable. Preferred alcohols are n-butanol and n-hexanol. Most preferred is n-hexanol.

If the polymer in the electrocatalyst coating composition is not in sulfonic acid form when used, a different liquid medium may be preferred in the ink. For example, if the one of the preferred polymers described above has its sulfonated groups in the form of sulfonyl fluoride, a preferred liquid medium is a high-boiling fluorocarbon such as “Fluorinert” FC-40 manufactured by 3M.

Handling properties of the ink, e.g. drying performance, can be modified by the inclusion of compatible additives such as ethylene glycol or glycerin up to 25% by weight based on the total weight of liquid medium.

It has been found that the commercially available dispersion of the acid form of the perfluorinated sulfonic acid polymer, sold by E.I. du Pont de Nemours and Company under the trademark Nafion®, in a water/alcohol dispersion, can be used, as starting material, for the preparation of an electrocatalyst coating composition suitable for use in flexographic or pad printing.

In the electrocatalyst coating composition, it is preferable to adjust the amounts of electrocatalyst, ion exchange polymer and other components, if present, so that the electrocatalyst is the major component by weight of the resulting electrode. The weight ratio of electrocatalyst to ion exchange polymer in the electrode is about 2:1 to about 10:1.

Utilization of the electrocatalyst coating technique in accordance with the process of the present invention can produce a wide variety of printed layers which can be of essentially any thickness ranging from very thick, e.g., 20 μm or more very thin, e.g., 1 μm or less. This full range of thickness can be produced without evidence of cracking, loss of adhesion, or other inhomogenieties. Thick layers, or complicated multi-layer structures, can be easily achieved by utilizing the pattern registration available using flexographic or pad printing technology to provide multiple layers deposited onto the same area so that the desired ultimate thickness can be obtained. On the other hand, only a few layers or perhaps a single layer can be used to produce very thin electrodes. Typically, a thin layer ranging from 1 to 2 μm may be produced with each printing with lower % solids formulations.

In embodiment of the invention, the dried cathode layer is less than 9 μm (microns), or less than 7 μm (microns), or between 6 μm (microns) and 4 μm (microns). It has been quite unexpectedly discovered that this thin cathode layer in combination with the thin reinforced composite polymer membrane provide the unexpected and superior results combining excellent high power performance with low water and methanol crossover in a DMFC application.

The multilayer structures mentioned above permit the electrocatalyst coating to vary in composition, for example the concentration of precious metal catalyst can vary with the distance from the substrate, e.g. membrane, surface. In addition, hydrophilicity can be made to change as a function of coating thickness, e.g., layers with varying ion exchange polymer EW can be employed. Also, protective or abrasion-resistant top layers may be applied in the final layer applications of the electrocatalyst coating.

Composition may also be varied over the length and width of the electrocatalyst coated area by controlling the amount applied as a function of the distance from the center of the application area as well as by changes in coating applied per pass. This control is useful for dealing with the discontinuities that occur at the edges and corners of the fuel cell, where activity goes abruptly to zero. By varying coating composition or plate image characteristics, the transition to zero activity can be made gradual. In addition, in liquid feed fuel cells, concentration variations from the inlet to the outlet ports can be compensated for by varying the electrocatalyst coating across the length and width of the membrane.

Catalyst coated membranes as described herein (hereinafter CCM's) are composed of a reinforced composite polymer membrane, a catalyst containing anode layer and a catalyst containing cathode layer.

CCM's be prepared by coating opposite sides of the polymer membrane with electrocatalyst coating compositions to form a catalyst coated membrane. The electrocatalyst coating compositions may be coated on the polymer membrane using a wide variety of coating techniques. Some include screen-printing, offset printing, gravure printing, flexographic printing, pad printing, slot die coating, doctor blade coating, dip coating or spray coating. An MEA may be formed by placing the CCM between two separate gas diffusion backings.

CCM's gas diffusion backings coated with electrocatalyst coating compositions may be provided with post treatments such as calendering, vapor treatment to affect water transport, or liquid extraction to remove trace residuals from any of the above earlier steps. If the membrane dispersion or solution used was the precursor of the highly fluorinated ionomer, after application of the solution or dispersion the sandwich formed may be subjected to a chemical treatment to convert the precursor to the ionomer, subject to the cautionary principles described herein where such treatment does not disturb the integrity of any other layer in the CCM or MEA device.

In embodiments of the invention CCM's in accordance with the invention use a Nafion® XL™ 100 Membrane which is about 30 microns or less (1.25 mils or less), or 30-25 microns (1.25 to 1.0 mils), or 25-20 microns (1.0 to 0.8 mils) or as thin as 20-15 microns (0.8 to 0.6 mils) and is a reinforced composite polymer membrane made of perfluorosulfonic acid (“PFSA”) ionomer in the proton form. In embodiments of the invention, cerium-boro-silicate nano-particles may have been incorporated into the Nafion® XL™ 100 Membrane.

As discussed above, a CCM in accordance with the invention includes an anode electrode on one side of the reinforced composite polymer membrane and a cathode electrode on the opposite side of the membrane. The anode and cathode electrodes each include a catalyst supported on carbon particles, and these catalyst/carbon particles are distributed in a porous PFSA ionomer structure. In embodiments of the invention the cathode electrodes include a platinum catalyst, and the anode electrodes include a platinum/ruthenium catalyst. An anode gas diffusion backing may be attached to the exposed face of the anode electrode, and a cathode gas diffusion backing may be attached to the exposed face of the cathode electrode to make a five layer MEA.

Although not limiting to the CCM in accordance with the invention, embodiments have been produced and tested in which the catalyst particles in the cathode electrode structures are comprised of about 67 wt % platinum and about 33 wt % carbon, and the catalyst particles in the anode electrode structures are comprised of about 52 wt % platinum, 27 wt % ruthenium and about 21 wt % carbon. The ionomer in both the anode and cathode electrode structures is DuPont Nafion® PFSA ionomer in the proton form, with an equivalent weight in the range of 920 to 1000, and more particularly may be 920. The catalyst to ionomer ratio for the cathode is 3.5:1, such that the cathode electrode is comprised of about 52 wt % platinum, about 26 wt % carbon, and about 22 wt % PFSA ionomer. The catalyst to ionomer ratio for the anode is 2:1, such that the anode electrode is comprised of about 35 wt % platinum, about 18 wt % ruthenium, about 14 wt % carbon, and about 33 wt % PFSA ionomer. The electrodes may be coated from a slot die coater using an electrode ink comprised of the carbon-supported Pt or Pt/Ru catalyst and the Nafion® ionomer dispersion in proton form diluted in a blend of n-propyl alcohol, iso-propyl alcohol, and small amounts of dipropylene-glycol monomethyl and deionized water. The anode ink may have a solids content of about 7 to 9% and a viscosity of about 50 centipoise at 20 s-1 shear rate. The cathode ink may have a solids content of about 11 to 13% and a viscosity of about 300 centipoise at 20 s-1 shear rate.

The electrodes may be slot die coated directly on one side of the Nafion® reinforced composite polymer membrane. Warm air is blown onto the catalyst ink to dry the ink. Alternately the electrode may be slot die coated onto a perfluoroalkoxy release layer to create an electrode decal. Warm air is blown onto the catalyst ink to dry the ink. As the propanol and other solvents evaporate from the electrode ink during the drying process, porous and granular electrode structures may be created that have visible cavities when viewed under a scanning electron microscope. This structure permits fuel and/or air or other reaction products to freely penetrate and contact the catalyst particles. The electrode decal may be subsequently decal-transferred onto the free side of the Nafion® reinforced composite polymer membrane under heat and pressure to provide the cathode electrode of the CCM. The heat and pressure may be applied by a hot roll laminator.

Although not limiting to the CCM in accordance with the invention, embodiments have been produced and tested in which the catalyst loading of the anode electrode is about 3.0 [Pt/Ru]/cm², and the dry coating thickness is about 1.6 mils. Although not limiting to the CCM in accordance with the invention, embodiments have been produced and tested in which the catalyst loading of the cathode electrode is 1.0 mg Pt/cm². The platinum loading of the cathode electrode Is about 0.5 mg Pt/cm², and the dry coating thickness is about 0.5 mil. Platinum loading may be measured by X-ray fluorescence. Electrode thickness may be measured with a stylus-type instrument that measures the high points and not the average thicknesses, and this relationship depends on surface roughness. Electrode thickness may also be confirmed by SEM analysis. The combination of the anode and cathode electrodes with the membrane is referred to herein as a catalyst-coated membrane (CCM).

In an MEA (5 layer), gas diffusion layers (GDL) are added on opposite sides of the CCM. The GDL may be a conductive support, such as a porous sheet structure made from carbon fibers, a porous cloth structure made from woven carbon fiber yarns, or a metal-mesh structure. Typically, the sheet or cloth structures are constructed from precursor materials, with the sheet or cloth structure being subsequently pyrolyzed to convert the precursor materials to the carbon form. In embodiments of the invention the GDLs used may be fibrous sheets made by a paper making process. The GDL may be pretreated with a PTFE dispersion to impart hydrophobicity (water shedding feature) to the porous GDL structure. In addition, one or both sides of a GDL may include a microporous layer (MPL) surface coating, consisting of carbon black and a PTFE binder to enhance electrical contact between the GDL and the electrode surface of the CCM. GDLs can range in thickness from 200 to 500 micrometers, depending on materials of construction, desired porosity and compressibility requirements.

### Experimental

### CCM Preparation

The catalyst coated membranes (CCM) of Example 1 in accordance with the invention were produced using the Nafion® XL™ 100 reinforced composite polymer membrane in the sulfonic acid form and having a thickness of about 1 mil and a size of about 4 inch×4 inch. A piece of dry membrane was used. For each test, a membrane was sandwiched between an anode electrode decal on one side of the membrane and a cathode electrode decal on opposite side of the membrane. The catalyst coated membranes of Comparative Example 1 were produced with 5 mil cast Nafion® N115 PFSA membrane available from E.I. du Pont de Nemours Company, Wilmington Del.

The catalyst particles in the cathode electrode were comprised of 67 wt % platinum, 33 wt % carbon, and the catalyst particles in the anode electrode were comprised of 52 wt % platinum, 27 wt % ruthenium and 21 wt % carbon. The ionomer in both the anode and cathode electrode structures is DuPont Nafion® PFSA ionomer in the proton form, with an equivalent weight of 920. The catalyst to ionomer ratio for the cathode was 3.5:1, and the catalyst to ionomer ratio for the anode was 2:1, such that the anode electrode is comprised of about 35 wt % platinum, about 18 wt % ruthenium, about 14 wt % carbon, and about 33 wt % PFSA ionomer. The thickness of the cathode layer in Example 1 was 0.5 mil and the thickness of the cathode layer in Comparative Example 1 was 1.0 mil.

Care was taken to ensure that the coatings on the two decals were registered with each other and were positioned facing the membrane. The entire assembly was placed between two preheated (to about 150° C.) 8 inch×8 inch plates of a hydraulic press and the plates of the press were brought together quickly until a force of 5000 pounds was reached. The sandwich assembly was kept under pressure for approximately 2 minutes and then the press was cooled for approximately 2 minutes to a temperature of less than 60° C. while maintaining the same pressure. Then the assembly was removed from the press and Kapton® films were slowly peeled off the electrodes on both sides of the membrane showing that the anode and cathode electrodes had been transferred to the membrane. Each CCM was carefully transferred to a zipper bag for storage and future use.

### Testing

CCM performance measurements were made employing a single cell test assembly obtained from Fuel Cell Technologies Inc, New Mexico. Membrane electrode assemblies having an active area of the cell of 25 cm² were made that comprised one of the above CCMs sandwiched between two sheets of the gas diffusion backing (taking care to ensure that the GDB covered the electrode areas on the CCM). Freudenberg H2315 I3 C1 was used as anode gas diffusion backing and the cathode diffusion backing was Freudenberg H2315 T10A. The microporous layer on the anode-side GDB was disposed toward the anode catalyst. Two 7 mil thick glass fiber reinforced silicone rubber gaskets (Furan—Type 1007, obtained from Stockwell Rubber Company) each along with a 1 mil thick FEP polymer spacer were cut to shape and positioned so as to surround the electrodes and GDBs on the opposite sides of the membrane and to cover the exposed edge areas of each side of the membrane. Care was taken to avoid overlapping of the GDB and the gasket material. The entire sandwich assembly was assembled between the anode and cathode flow field graphite plates of a 25 cm² standard single cell assembly (obtained from Fuel Cell Technologies Inc., Los Alamos, N. Mex.). The test assembly was also equipped with anode inlet, anode outlet, cathode gas inlet, cathode gas outlet, aluminum end blocks, tied together with tie rods, electrically insulating layer and the gold plated current collectors. The bolts on the outer plates of the single cell assembly were tightened with a torque wrench to a force of 2 ft. lbs. The single cell assembly was then connected to the fuel cell test station. The components in the test station included a supply of air for use as cathode gas; a load box to regulate the power output from the fuel cell; a MeOH solution tank to hold the feed anolyte solution; a liquid pump to feed the anolyte solution to the fuel cell anode at the desired flow rate; a condenser to cool the anolyte exiting from the cell from the cell temperature to room temperature and a collection bottle to collect the spent anolyte solution.

With the cell at room temperature, 1M MeOH solution and air were introduced into the anode and cathode compartments through inlets of the cell at flow rates of 1.55 cc/min and 202 cc/min, respectively. The temperature of the single cell was slowly raised until it reached 70° C. The methanol and air feed rates were maintained proportional to the current while the resistance in the circuit was varied in steps so as to increase current. The voltage at each current step was recorded so as to produce a current vs. voltage plot for the cell. Using this plot, the power density (expressed in mW/cm²) at a voltage of 400 mVolts was determined. At 400 mVolts, a power density of 120.7 mW/cm² and 110 mW/cm² were recorded for MEA's having 1 mil Nafion® XL™ 100 in accordance with the invention (Example 1) and 5 mil Nafion® N115 cast membranes (Comparative Example 1), respectively.

The durability test of the DMFC MEA's were carried out in a single cell with an active cross-sectional area of 25 cm². The anode chamber was fed with 1M methanol solution, with the flow rate of 0.5 ml min⁻¹, and the cathode chamber was fed with air at pressure of 0.2 MPa, with the flow rate of 150 sccm. The cell was discharged either in a galvanostatic mode or under a constant power load depending on the study. The discharge process was controlled by the DuPont's in-house Fuel Cell Testing system.

Methanol crossover was measured by a method originally developed by Los Alamos National laboratories and described in the Journal of the Electrochemical Society 147(2) 466-474 (2000). Water crossover was measured by operating the cell at 80° C. discharge and 200 mA/cm² in galvanostatic mode while collecting the water from the exhaust for a period of one hour and weighing the accumulated exhaust water. The results are shown in Table 1 below.

TABLE 1

| | Comparative | |
|---|---|---|
| Sample I.D. | Example 1 | Example 1 |
| Membrane | N115 | XL 100 |
| Crossover Current Density (mA/cm²) | 176.4 | 162.0 |
| Water Crossover (g) | 8.62 | 8.05 |

### Discussion of Figures and Testing Results

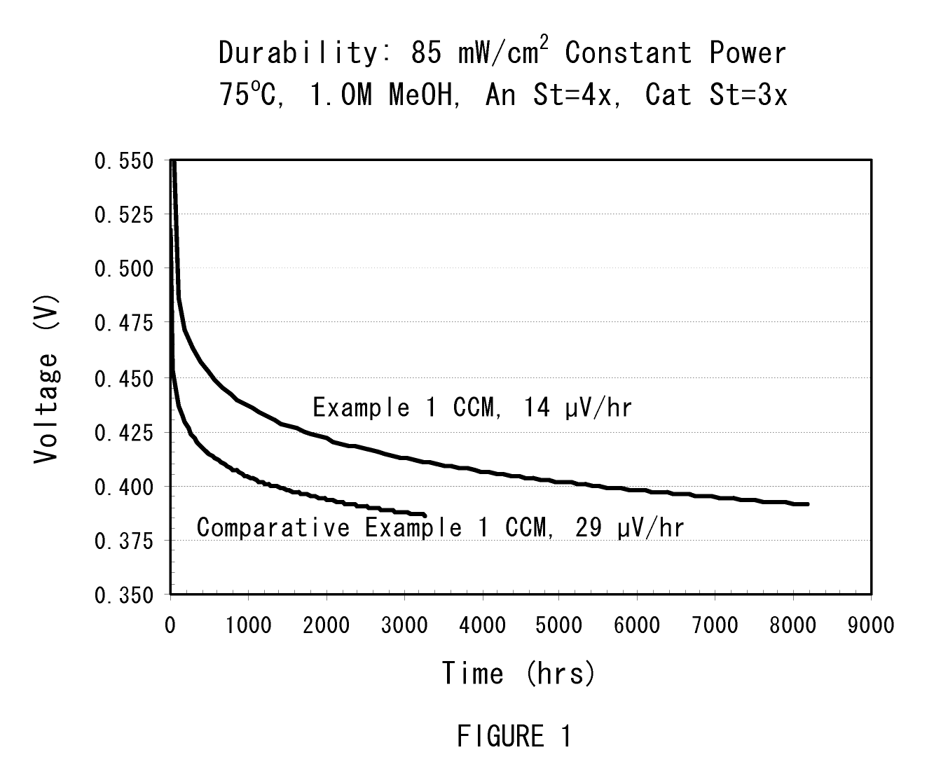

The invention provides a significant improvement in cell voltage and lifetime under varied operating condition. FIGS. 1 & 2 compare the performance of the Example 1 in accordance with the invention with Comparative Example 1, which represents a commercial product offered by the assignee in 2009. It is evident that the Example 1 in accordance with the invention has significantly higher cell voltage as well as higher durability. At 85 mW/cm2 the decay rate for Example 1 in accordance with the invention is 15 μV/hr as compared to 29 μV/hr for the current MEA, and at 100 mW/cm2 the decay rate is 50 μV/hr compared to 242 μV/hr for Comparative Example 1.

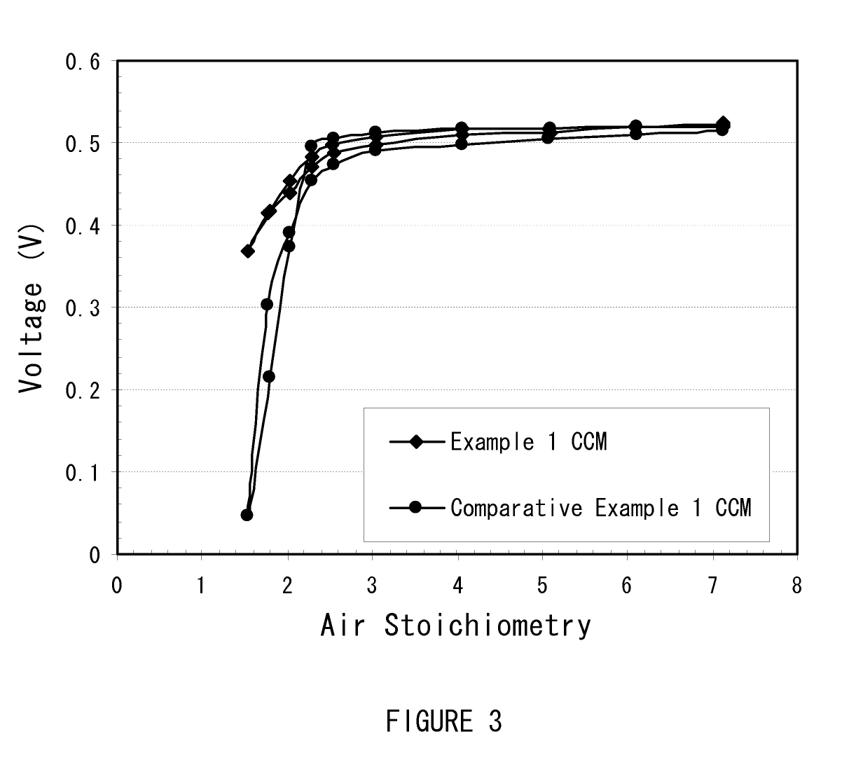

FIG. 3 shows the performance comparison of Example 1 in accordance with the invention with Comparative Example 1 at lower air stoichiometry. From the data it is evident that the invention represents a significant improvement. The performance drop for the device in accordance with the invention is 10% compared to 27% when the air stoichiometry is dropped from 3 to 2. Additionally, Comparative Example 1 is not functional at an air stoichiometry of 1.8, whereas the device in accordance with the invention is operational at air stoichiometry of 1.8.

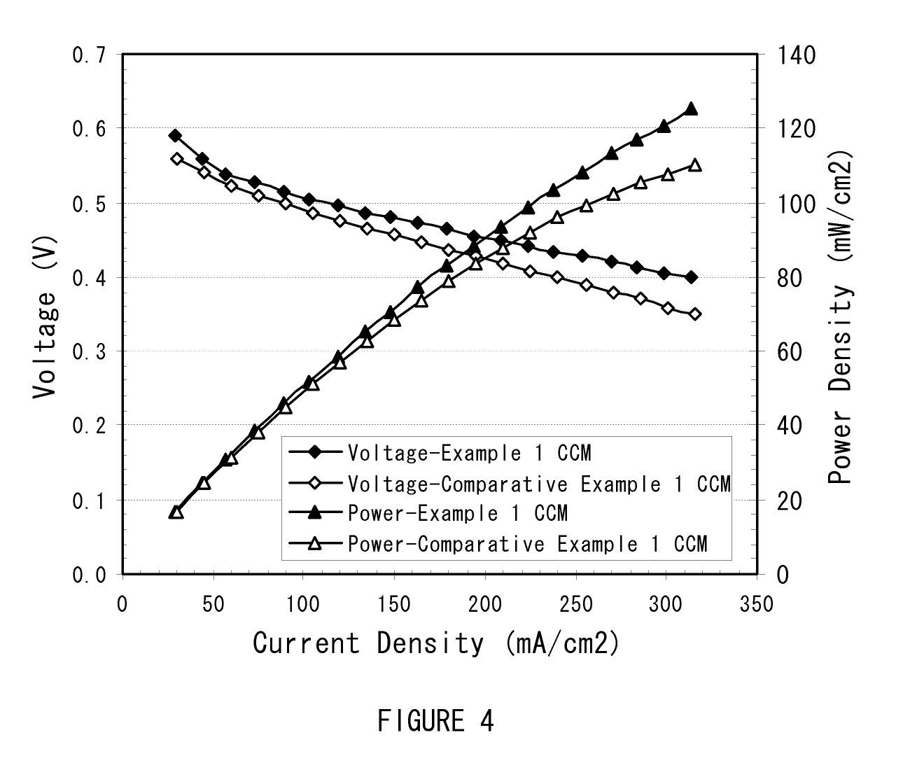

FIG. 4 shows that the device in accordance with the invention demonstrates at least a 10% improvement in both voltage and power density at current densities greater than 300 mA/cm².

In embodiments of the invention, a Nafion® XL™ 100 ePTFE reinforced membrane exhibits significantly lower MeOH crossover and improved low stoichiometry performance in DMFC testing as compared to NR212 and N115 membranes with identical electrode chemistry. The significance of this behavior is that it can lead to (a) higher power density from lower catalyst loadings, (b) current power densities at lower catalyst loadings, (c) lower membrane costs due to the use of less ionomeric material in thinner membrane and (d) smaller stack size due to the use of thinner (1 mil XL100 vs. 5 mil N115) membrane.

In embodiments of the invention, the problems of earlier DMFC membranes are solved by capitalizing on the low MeOH crossover and stoichiometry sensitivity observed when ePTFE reinforced membranes are used in place of 2 mil and 5 mil, NR212 and N115 with identical proton form electrodes.

What is claimed is:

1. A catalyst coated membrane for use in a direct methanol fuel cell comprising: an anode layer, a cathode layer having a thickness less than 7 microns, a reinforced ionomer membrane having a thickness of 30 microns or less, wherein said reinforced ionomer membrane is disposed between and in direct contact with said anode and said cathode.

2. The catalyst coated membrane of claim 1 wherein said reinforcement is ePTFE and said reinforced ionomer membrane comprises perfluorosulfonic acid ionomer which has substantially all of the functional groups being represented by the formula —SO₃X wherein X is H.

3. The catalyst coated membrane of claim 1 wherein said reinforced cathode layer has a thickness of between 4 and 6 microns.

4. The catalyst coated membrane of claim 1 wherein said reinforced ionomer membrane has a thickness 25 microns or less.

5. The catalyst coated membrane of any of claims 1 to 4 having at least 10% higher cell voltage at high current density, when compared to a catalyst coated membrane having a 5 mil thick non-reinforced ionomer membrane and a 1 mil thick cathode layer.

6. The catalyst coated membrane of any of claims 1 to 4 having a decay rate of less than 20 μV/hr at 85 mW/cm².

7. The catalyst coated membrane of any of claims 1 to 4 having a decay rate of 15 μV/hr at 85 mW/cm².

8. The catalyst coated membrane of any of claims 1 to 4 having a decay rate of less than 100 μV/hr at 100 mW/cm².

9. The catalyst coated membrane of any of claims 1 to 4 having a decay rate of 50 μV/hr at 100 mW/cm².

10. The catalyst coated membrane of any of claims 1 to 4 having a performance drop of less than 15% when air stoichiometry is dropped from 3 to 2, when compared to a catalyst coated membrane having a 5 mil thick non-reinforced ionomer membrane and a 1 mil thick cathode layer.

11. The catalyst coated membrane of any of claims 1 to 4 having a performance drop of 10% when air stoichiometry is dropped from 3 to 2, when compared to a catalyst coated membrane having a 5 mil thick non-reinforced ionomer membrane and a 1 mil thick cathode layer.

12. The catalyst coated membrane of any of claims 1 to 4 having functional voltage output when air stoichiometry is 1.8.
